(19) United States
(12) Patent Application Publication
(10) Pub. No.: US 2007/0200481 A1
(43) Pub. Date: Aug. 30, 2007

(54) IMAGE DISPLAY APPARATUS

(75) Inventor: AKIRA HAYAMA, Kanagawa-Ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/678,900

(22) Filed: Feb. 26, 2007

(30) Foreign Application Priority Data
Feb. 28, 2006 (JP) 2006-052330

(51) Int. Cl. H01J 63/04; H01J 1/62

(52) U.S. Cl. 313/495

(57) ABSTRACT

An image display apparatus has an electron source on which a plurality of electron-emitting devices are arranged, an irradiated member which is arranged so as to be opposed to the electron source to form luminescent spots on different locations, respectively, in response to respective electron-emitting devices due to irradiation of electrons emitted from the electron-emitting devices, a deflector for deflecting trajectory of the electron emitted from the electron-emitting devices, and a correction circuit for correcting the light quantity of the luminescent spot. The correction circuit corrects a visual unevenness in luminance by making a correction in response to the interval between two luminescent spots and the interval between other luminescent spots adjacent to the two luminescent spots so as to improve a quality of an image.

### BACKGROUND OF THE INVENTION

1. Field of the Invention

The present invention relates to an image display apparatus.

2. Description of the Related Art

Japanese Patent Application Laid-Open No. 2003-29697 and U.S. Pat. No. 7,142,177 B2 disclose a method for correcting visual unevenness in luminance due to deflection of beams emitted from adjacent electron-emitting devices placed on opposite sides of a spacer.

### SUMMARY OF THE INVENTION

The present invention is directed to realize a good image quality in an image display apparatus.

According to a display apparatus for displaying an image by using an electron-emitting device and a luminescent body emitting a light receiving irradiated electrons emitted from the electron-emitting device, an image is formed by many luminescent spots. In this case, it has been known that nonuniformity of intervals between luminescent spots is recognized as a visual unevenness in luminance.

Japanese Patent Application Laid-Open No. 2003-29697 and U.S. Pat. No. 7,142,177 B2 disclose a method for correcting visual unevenness in luminance in the vicinity of a spacer. Due to earnest consideration by the inventors of the present invention, it has been known that a degree of deviation of a luminescent spot position is not always uniform. For example, it has been known that the positional deviation of the adjacent luminescent spots placed on opposite sides of the spacer is not always generated symmetrically with respect to the spacer in a precise sense. According to the present invention, it is possible to improve an image quality by carrying out an appropriate correction of light quantity when positional relationship of the luminescent spots satisfy a specific condition.

An object of the present invention is to provide an image display apparatus which can improve an image quality.

An image display apparatus according to a first aspect of the present invention comprises: a plurality of electron-emitting devices; an irradiated member which is arranged so as to be opposed to the plurality of electron-emitting devices to form luminescent spots on different locations, respectively, in response to respective electron-emitting devices due to irradiation of electrons emitted from the electron-emitting devices; a plurality of deflectors for deflecting trajectories of the electrons emitted from the electron-emitting devices; and a correction circuit for correcting the light quantity of the luminescent spot;

wherein the plurality of deflectors includes at least first and second deflectors which are located at a distance where three or more electron-emitting devices can be arranged in a first direction;

among four luminescent spots A2, A1, B1, and B2 formed adjacent in sequence, respectively, by four electron-emitting devices arranged in the first direction, the first deflector is located between the luminescent spots A1 and B1;

the interval between the luminescent spots A1 and B1 in the first direction is narrower than the average value of the intervals in the first direction of the adjacent luminescent spots between the first and second deflectors and the interval between the luminescent spots A2 and A1 in the first direction is narrower than the interval between the luminescent spots B1 and B2 in the first direction; and

the correction circuit makes a correction so that the light quantities of the luminescent spots A1 and B1 are relatively smaller than the light quantities of the luminescent spots A2 and B2 and the light quantity of the luminescent spot A1 is relatively smaller than the light quantity of the luminescent spot B1 when an input signal is a signal to require the same light quantities from the luminescent spots A2, A1, B1, and B2.

Further, such a correction need not be always carried out when the input signal is a signal for requiring the same light quantity from the luminescent spots A2, A1, B1, and B2. The correction may be carried out only in the case that the visual unevenness in luminance becomes a problem when the intervals of the luminescent spots satisfy the above-described conditions.

Still further, according to the invention according to the first aspect, the correction circuit may carry out correction to relatively reduce the light quantity of the luminescent spot A2 than that of the luminescent spot B2.

In addition, an image display apparatus according to a second aspect of the present invention comprises: a plurality of electron-emitting devices; an irradiated member which is arranged so as to be opposed to the plurality of electron-emitting devices to form luminescent spots on different locations, respectively, in response to respective electron-emitting devices due to irradiation of electrons emitted from the electron-emitting devices; a plurality of deflectors for deflecting trajectories of the electrons emitted from the electron-emitting devices; and a correction circuit for correcting the light quantity of the luminescent spot;

wherein the plurality of deflectors includes at least first and second deflectors which are located at a distance where three or more electron-emitting devices can be arranged in a first direction;

among four luminescent spots A2, A1, B1, and B2 formed adjacent in sequence, respectively, by four electron-emitting devices arranged in the first direction, the first deflector is located between the luminescent spots A1 and B1;

the interval between the luminescent spots A1 and B1 in the first direction is broader than the average value of the intervals in the first direction of the adjacent luminescent spots between the first and second deflectors and the interval between the luminescent spots A2 and A1 in the first direction is broader than the interval between the luminescent spots B1 and B2 in the first direction; and

the correction circuit makes a correction so that the light quantities of the luminescent spots A1 and B1 are relatively larger than the light quantities of the luminescent spots A2 and B2 and the light quantity of the luminescent spot A1 is relatively larger than the light quantity of the luminescent spot B1 when an input signal is a signal to require the same light quantities from the luminescent spots A2, A1, B1, and B2.

Also according to the second aspect, the correction may be carried out only in the case that the visual unevenness in luminance becomes a problem when the intervals of the luminescent spot satisfy the above-described conditions.

In addition, according to the second aspect, the correction circuit may carry out correction to relatively increase the light quantity of the luminescent spot A2 than that of the luminescent spot B2.

According to the present invention, the visual unevenness in luminance is corrected, so that the image quality of the image display apparatus can be improved.

### BRIEF DESCRIPTION OF THE DRAWINGS

FIG. 1 is a schematic perspective view of an image display apparatus according to an example of the present invention;

FIG. 2 is a plan view showing part of the luminescent spot array shown in FIG. 1;

FIG. 3 is a schematic perspective view of an image display apparatus according to a first example of the present invention;

FIG. 4 is a partial plan view of an electron source provided in an image display apparatus;

FIG. 5 is a schematic perspective view of a spacer which is disposed in the image display apparatus according to the first example of the present invention;

FIG. 6 shows light quantity data of luminescent spots according to the first example of the present invention;

FIG. 7 shows profile data of luminescent spots according to the first example of the present invention;

FIG. 8 is a diagram showing arrangement of electron-emitting regions and luminescent spots in relation to each other according to the first example of the present invention;

FIG. 9 is a block diagram of the image display apparatus including a drive circuit according to the first example of the present invention;

FIG. 10 is a diagram showing arrangement of electron-emitting regions and luminescent spots in relation to each other according to a third example of the present invention;

FIG. 11 is a schematic perspective view of an image display apparatus according to a fifth example of the present invention; and

FIG. 12 is a plan view showing part of the luminescent spot array according to the example of the present invention.

### DESCRIPTION OF THE EMBODIMENTS

The embodiments of the present invention will be described in detail below by way of example with reference to the drawings. However, the dimensions, materials, shapes, relative arrangements of the components cited in relation to the embodiment are not intended to limit the scope of the present invention unless otherwise stated.

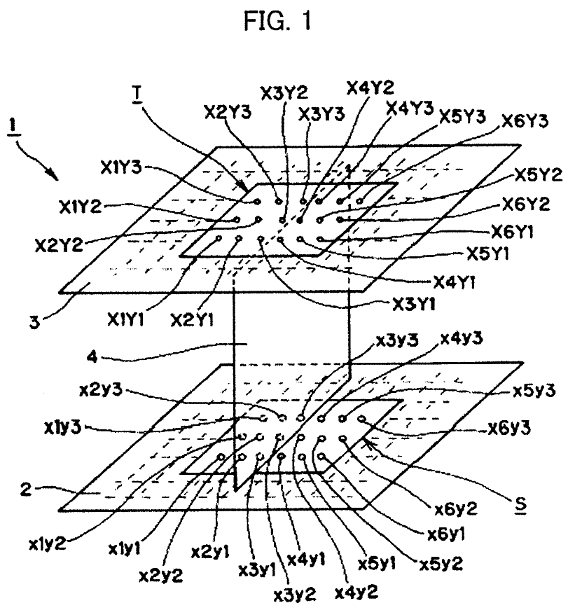

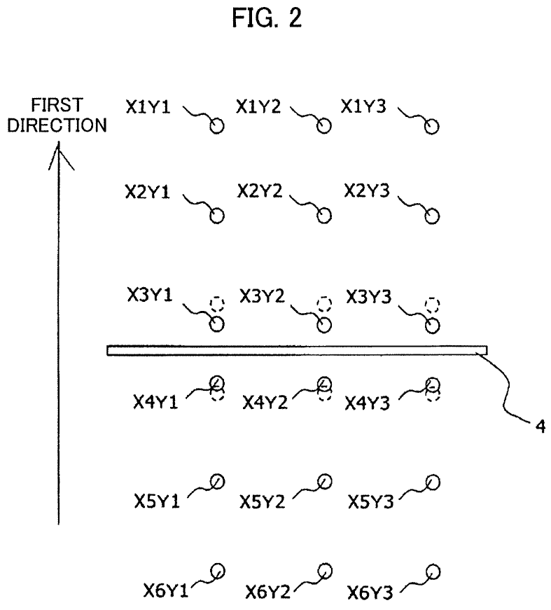

With reference to FIG. 1 and FIG. 2, an image display apparatus and a method for driving the image display apparatus according to the present embodiment will be described below. FIG. 1 is a schematic perspective view of an image display apparatus according to the present embodiment and FIG. 2 is a plan view showing part of the luminescent spot array shown in FIG. 1.

As shown in FIG. 1, an image display apparatus 1 according to the present embodiment is provided with an electron source 2 having a plurality of electron-emitting devices arrayed and an irradiated member 3 which is arranged so as to be opposed to the electron source 2. For the irradiated member 3, the configuration where a luminescent body emitting a light due to irradiation of electrons can be preferably employed on a position where the electrons collide with each other. As the luminescent body, a phosphor can be employed.

The irradiated member 3 may form a luminescent spot due to collision of electrons emitted from the electron source 2 and the irradiated member 3 may form luminescent spots on different positions, respectively, in response to respective electron-emitting devices. As a result, by controlling the electron-emitting device for emitting electrons depending on the image information to be formed by means of a drive circuit (not illustrated), it is possible to form a luminescent spot on a position corresponding to the image information, and thereby, the image can be formed.

Here, the electrons emitted from the electron-emitting device may form a trajectory in accordance with an electric field formed in the image display apparatus. When the electric field to be formed in the image display apparatus is uniform, array of the luminescent spots on the irradiated member 3 is identical with array of the electron-emitting device in the case that the electrons are emitted from the all electron-emitting devices.

For example, as shown in FIG. 1, assuming that (the electron-emitting regions of) the electron-emitting devices are arrayed in a matrix in an area S of the electron source 2, array of the luminescent spots in an area T on the irradiated member 3 corresponding to the array of the electron-emitting devices may also form the same matrix.

According to the present application, the position of the electron-emitting device is defined to be a position of an electron-emitting region of the electron-emitting device. If the electron-emitting region is spread, a gravity position of the spread shape is defined to be the position of the electron-emitting region.

In addition, one electron-emitting device may have a plurality of electron-emitting regions. In this case, the area made by connecting the adjacent electron-emitting regions among the plurality of electron-emitting regions by a straight line and including the plurality of electron-emitting regions is assumed. Then, the gravity position of this area is defined to be a position of one electron-emitting device having these plural electron-emitting regions.

One luminescent spot may constitute one pixel, or a sub pixel. In the case of depicting many colors by one pixel, this pixel is constituted by sub pixels each of which emits a light of different original color (here, red, blue, and green). As a result, if the present image display apparatus is a display apparatus for effecting a monochrome display, one luminescent spot may correspond to one pixel, and if the present image display apparatus is a display apparatus for effecting a multiple color display, one luminescent spot may correspond to a sub pixel.

Further, one luminescent spot is formed by an electron-emitting device which is driven in response to a pixel signal or a sub pixel signal (for example, equivalent to one R (red) signal, one B (blue) signal, and one G (green) signal).

In the case that one electron-emitting device has a plurality of electron-emitting regions, the irradiation distribution of an electron from the plurality of electron-emitting regions may not be superimposed on the irradiated member. In this case, the entire area emitting a light due to each irradiation of a plurality of electron-emitting regions is made into one luminescent spot.

A circle on the area S shown in FIG. 1 represents a position of the electron-emitting device which is determined as described above. In addition, a circle on the area T represents a position of the luminescent spot which is determined as described above.

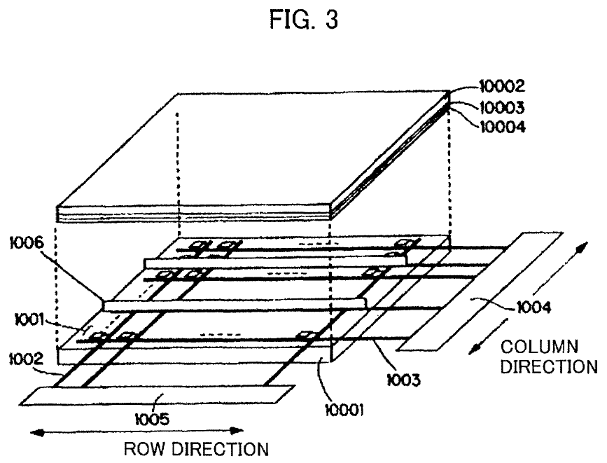

In FIG. 3 which is a schematic view of a display panel constituting the display apparatus, a plurality of spacers equivalent to a deflector is provided. The spacers are located at a distance where three or more electron-emitting devices can be arranged. The spacer may be disposed so as to be capable of maintaining a strength of a display panel, and preferably, the spacer may be disposed every ten or more scan lines.

FIG. 1 and FIG. 2 are schematic views showing a position of an electron-emitting device and a position of a luminescent spot in the vicinity of one spacer. According to this embodiment, as the spacer equivalent to the deflector, a plate-like spacer having a longitudinal direction along a scan line for matrix-driving the electron-emitting device is employed. The electron-emitting devices are arranged equally spaced along a direction where the scan line extends (namely, a row direction). A modulation line for applying a modulation signal has a longitudinal direction which is perpendicular to the row direction. According to the present embodiment, the modulation line is a linear shape. In addition, the electron-emitting devices in the adjacent rows are arranged so as to be arranged in a longitudinal direction of the modulation line. Accordingly, if there is no affect due to uneven deflection by the deflector, respective luminescent spots are arranged in a row direction and they are arranged equally spaced also in a direction perpendicular to the row direction (a first direction).

In other words, as shown in FIG. 1, assuming that there is the area S arranged 6 rows×3 columns equally spaced for any of the row direction and the column direction, it is ideal that the luminescent spot on the area T on the irradiated member 3 is also arrayed in a matrix of 6 rows×3 columns equally spaced for any of the row direction and the column direction. Here, the luminescent spots of 6 rows×3 columns are shown in one drawing, however, it is not necessary that these luminescent spots emit a light at the same time but they may be a plurality of luminescent spots emitting a light in series.

Further, according to the example shown in FIG. 1, the electrons emitted from an electron-emitting region xnym form a luminescent spot XnYm (n=1 to 6, m=1 to 3).

However, when there is a deflector 4 for deflecting an electron trajectory such as a spacer, a disturbance is generated in the array of the luminescent spots. In other words, an error is generated on the position of the luminescent spot.

In other words, as shown in FIG. 1 and FIG. 2, if there is the deflector 4, the emitted electron suffers the affect of the deflector 4 and the deflection is generated on the electron trajectory. In fact, it seems that the electrons emitted from the all electron-emitting devices suffer the influence of the deflector 4, however, on the position separated from the deflector 4 to some extent, there is small influence.

FIG. 2 shows an example assuming that only luminescent spots X3Y1, X3Y2, X3Y3, X4Y1, X4Y2, and X4Y3 in the vicinity of the deflector 4 suffer the influence of the deflector 4. Assuming that there is no deflector 4, the luminescent spot is formed on a position represented by a dashed line (a reference position) in FIG. 2, but, on the contrary, as a result of deflection, the luminescent spot is formed on a position represented by a solid line. As a result, a distance between the position represented by the dashed line and the position represented by the solid line is defined as an interval error. According to this example, a positional deviation quantity from each of reference positions of the luminescent spots other than the luminescent spots X3Y1, X3Y2, X3Y3, X4Y1, X4Y2, and X4Y3 is zero. In addition, a positional deviation quantity from each of reference positions (the dashed-line position) of the luminescent spots X3Y1, X3Y2, X3Y3, X4Y1, X4Y2, and X4Y3 is not zero. Further, the positional deviation quantities of the luminescent spot X3Y1 and the luminescent spot X4Y1 placed on opposite sides of the deflector 4 are different. In the same way, the positional deviation quantities of the luminescent spot X3Y2 and the luminescent spot X4Y2 from the reference position are also different and the positional deviation quantities of the luminescent spot X3Y3 and the luminescent spot X4Y3 from the reference position are also different.

According to this configuration, the interval between two luminescent spots in adjacent placed on opposite sides of the deflector 4 (for example, the interval between the luminescent spot X3Y1 and the luminescent spot X4Y1) is narrower particularly as compared to the interval between two luminescent spots (for example, the interval between the luminescent spot X1Y1 and the luminescent spot X2Y1) adjacent to each other placed on one side of the deflector, where these two luminescent spots are adjacent to each other in a direction where these two luminescent spots are arranged (a first direction shown in FIG. 2).

Here, it is to be noted that the reference position can be determined by supposing the case that there is no deflection due to the deflector and assuming that the positions of the electron-emitting device and the luminescent spot corresponding to this device in relation to each other are equal among the all electron-emitting devices. Further, according to the present application, as an interval which is an object of comparison for determining if the interval is wide or narrow (namely, a reference interval), respective intervals among luminescent spots adjacent to each other in the first direction in the two deflectors are measured and its average value is employed.

The example shown in FIG. 2 illustrates the case that two luminescent spots adjacent to each other placed on opposite sides of the deflector 4 are deflected so as to come close to the deflector 4. The deflection given to the electrons is different depending on the configuration of the deflector. Specifically, since an electric property of the deflector influences the electric field around the deflector, the electric property of the deflector largely influences the direction of the deflection and the quantity of the deflection. Depending on the electric property of the deflector, two luminescent spots adjacent to each other placed on opposite sides of the deflector 4 may be deflected so as to be separated from the deflector 4. As the electric property of the deflector, an electric conductivity of the deflector, existence or nonexistence of an electrode to be disposed to the deflector, and the position of the electrode or the like may be considered. In addition, the position of the deflector also influences the direction of the deflection and the quantity of the deflection. For example, sometimes two electron-emitting devices forming two luminescent spots adjacent to each other placed on opposite sides of the deflector respectively are not located on a position which is perfectly symmetrical to the deflector. In this case, if the deflector has a property to provide deflection so as to allow the luminescent spot to come close to the deflector, any of two luminescent spots adjacent to each other placed on opposite sides of the deflector is deflected so as to come close to the deflector from the reference position, however, each deflection quantity is different. Sometimes it is intended that two electron-emitting devices corresponding to two luminescent spots adjacent to each other placed on opposite sides of the deflector are not formed on a position which is perfectly symmetrical to the deflector. In addition, even if it is intended that two electron-emitting devices corresponding to two luminescent spots adjacent to each other placed on opposite sides of the deflector are formed on a position which is perfectly symmetrical to the deflector, sometimes this can not be realized depending on a manufacturing accuracy. In addition, it is not possible to completely deny the possibility of the configuration and the array of the deflector such that one of two luminescent spots adjacent to each other placed on opposite sides of the deflector is deflected so as to come close to the deflector and other one of them is deflected so as to be separated from the deflector or the configuration and the array of the deflector such that only one of two luminescent spots is deflected.

It is identified that visual unevenness in luminance is also generated in an image to be formed when there is unevenness in array of the luminescent spots.

Therefore, according to the present embodiment, by making distribution of visual brightness (a distribution of a subjective brightness) uniform due to correction of a light quantity, unevenness in image is removed. Further, unevenness in array of the luminescent spots (ununiformity of the interval between luminescent spots, and ununiformity of the positional deviation quantity of each luminescent spot and/or positional deviation direction) of the beams emitted from the electron-emitting device, of which at least one factor is that the moving quantity due to deflection and the moving direction due to deflection are different, may be left as it is. By correcting a drive condition of the electron-emitting device due to correction of light quantity, unevenness in array of the luminescent spots may be also turned out to be improved, however, an object of the present invention is not to completely remove unevenness in array of the luminescent spots by correction. An object of the present invention is to realize the state that the visual unevenness is reduced by correcting the light quantity even if there is unevenness in array of the luminescent spots.

More specifically, the distribution of the visual brightness is uniform by carrying out the correction of the light quantity in response to intervals of the adjacent luminescent spots among a plurality of luminescent spots.

The configuration such that the deflector 4 is located between the luminescent spots A1 and B1 among four luminescent spots arranged in the order of A2, A1, B1, and B2 is supposed. Further, when the deflector 4 is arranged longitudinally, the luminescent spots A2, A1, B1, and B2 may be arranged from left to right or from right to left. When the deflector 4 is arranged laterally, the luminescent spots A2, A1, B1, and B2 may be arranged from top to down or from down to top.

When the interval between the luminescent spots A1 and B1 is narrower than a predetermined reference interval in such an array, the part where the luminescent spots A1 and B1 are located is seen visually brighter than its periphery. In addition, the visual brightness is also influenced by the fact that the interval between the luminescent spots A2 and A1 is relatively narrower than the interval between the luminescent spots B1 and B2. The visual unevenness in luminance becomes remarkable when display on the basis of the image signal to require the same brightness from the all pixels is carried out without correction of the present invention. For example, if an image signal to make the entire screen into white with a specific brightness is input, each electron-emitting devices is driven so that the light quantities of the all luminescent spots are uniformed unless the correction according to the present invention is carried out. In this case, if the intervals of the luminescent spots are not uniform, the visual unevenness in luminance is generated even if the light quantity of each luminescent spot is the same. Therefore, when the interval between the luminescent spots A1 and B1 is narrower than the reference interval and the interval between the luminescent spots A2 and A1 is narrower than the interval between the luminescent spots B1 and B2, according to the present invention, correction such that the light quantities of the luminescent spots A1 and B1 are relatively reduced than the light quantities of other luminescent spots A2 and B2 and the light quantity of the luminescent spot A1 is relatively reduced than the light quantity of the luminescent spot B1 is carried out by the correction circuit and the like. Due to such a light quantity correction, the visual brightness of the part where the luminescent spots A2, A1, B1, and B2 are located is substantially uniformed.

In addition, when the interval between the luminescent spots A1 and B1 is larger than a predetermined reference interval in the above-described array, the part where the luminescent spots A1 and B1 are located is seen visually darker than its periphery. In addition, the visual brightness is also influenced by the fact that the interval between the luminescent spots A2 and A1 is relatively broader than the interval between the luminescent spots B1 and B2. Therefore, when the interval between the luminescent spots A1 and B1 is broader than the reference interval and the interval between the luminescent spots A2 and A1 is broader than the interval between the luminescent spots B1 and B2, according to the present invention, correction such that the light quantities of the luminescent spots A1 and B1 are relatively increased than the light quantities of other luminescent spots A2 and B2 and the light quantity of the luminescent spot A1 is relatively increased than the light quantity of the luminescent spot B1 is carried out by the correction circuit and the like. Due to such a light quantity correction, the visual brightness of the part where the luminescent spots A2, A1, B1, and B2 are located is substantially uniformed.

Further, as a plurality of luminescent spot groups, luminescent spot groups arranged in order in any direction of a row direction or a column direction may be intended. Then, the interval between the adjacent luminescent spots may be measured from among these luminescent spots.

For example, according to the example shown in FIG. 2, the luminescent spot groups including six luminescent spots X1Y1, X2Y1, X3Y1, X4Y1, X5Y1, and X6Y1 arranged in a row direction approximately in a liner shape will be considered.

Then, as described above, the interval between the luminescent spots X3Y1 and X4Y1 is narrower as compared to the interval between other luminescent spots, and the interval between the luminescent spots X5Y1 and X4Y1 is narrower as compared to the interval between the luminescent spots X2Y1 and X3Y1. Therefore, by correcting the light quantities of these luminescent spots X3Y1 and X4Y1 so as to be relatively smaller than those of the luminescent spots X2Y1 and X5Y1 and correcting the light quantity of the luminescent spot X4Y1 so as to be relatively smaller than that of the luminescent spot X3Y1, it is possible to uniform the distribution of the visual brightness.

Here, it is to be noted that correction of reducing the light quantity of a predetermined luminescent spot (a correction object luminescent spot) is correction of reducing the light quantity of the correction object luminescent spot itself. For example, it is assumed that there are a correction object luminescent spot and another luminescent spot (namely, a luminescent spot which is not corrected or is corrected at a lower level). In this case, the correction of reducing the light quantity of a predetermined luminescent spot means a correction so as to reduce the light quantity of the correction object luminescent spot than the light quantity of another luminescent spot when a signal to require the same light quantity from the correction object luminescent spot and another luminescent spot is given from the outside.

In addition, it is to be noted that correction of increasing the light quantity of a predetermined luminescent spot (a correction object luminescent spot) is correction of increasing the light quantity of the correction object luminescent spot itself. For example, it is assumed that there are a correction object luminescent spot and another luminescent spot (namely, a luminescent spot which is not corrected or is corrected at a lower level). In this case, the correction of increasing the light quantity of a predetermined luminescent spot means a correction so as to increase the light quantity of the correction object luminescent spot than the light quantity of another luminescent spot when a signal to require the same light quantity from the correction object luminescent spot and another luminescent spot is given from the outside.

In other words, according to the present embodiment, even in the case that the image signal input from the outside requires the same light quantity from the different luminescent spots, if the intervals between the luminescent spots are not uniform and there is visual unevenness in luminance, the visual unevenness in luminance is reduced by differentiating the light quantities of the luminescent spots.

Further, it is possible to set the object luminescent spot group on an arbitrary position in the irradiated member 3, however, correction of the light quantity of the luminescent spot need not be carried out on the position where a difference in the intervals between the luminescent spots does not become a problem. In addition, it is not necessary to carry out correction in the all areas where visual unevenness in luminance due to ununiformity in the intervals between the luminescent spots is identified but correction may be carried out only in a predetermined area. As a result, the present embodiment is applied to the luminescent spot groups on at least one place among a plurality of luminescent spots.

In addition, as shown in FIG. 2, in the case that the deflector 4 is arranged so as to extend in a predetermined direction (in FIG. 2, a direction in parallel to a row direction) and the distances between respective electron-emitting devices arranged in the predetermined direction and the deflector are equal, the correction of the light quantity can be carried out uniformly. For example, when the deflection quantities of the luminescent spots X3Y1, X3Y2, and X3Y3 are identical and the deflection quantities of the luminescent spots X4Y1, X4Y2, and X4Y3 are identical, the light quantity correction may be carried out uniformly for the electron-emitting devices which are arranged in the predetermined direction.

Accordingly, in the configuration shown in FIG. 2, for example, obtaining a light quantity integrated value of each row or a position of a peak of its average value by measuring, the light quantity correction may be carried out on the entire row depending on the correction quantity in response to bias of intervals of the peaks.

Here, it is assumed in this example that respective luminescent spots are located on a straight line, however, there is no need for the luminescent spots to be located exactly on a straight line. Even if they are displaced from a straight line, the present invention can be applied if the intervals between luminescent spots are nonuniform or positional deviation of luminescent spots from their respective reference positions on a virtual straight line is nonuniform when the luminescent spots are projected on the virtual straight line (line which extends in the first direction).

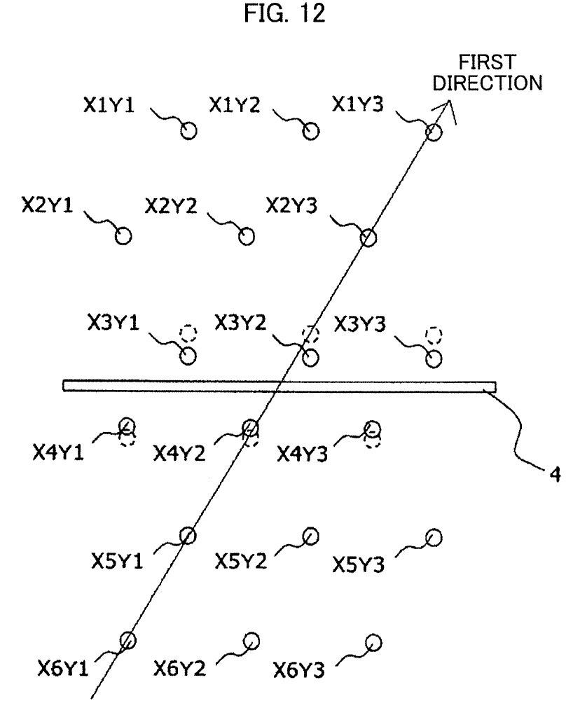

For example, various configurations such that the electron-emitting devices which are connected to the same column-directional wire are arranged being displaced in a row direction among the adjacent rows can be employed. FIG. 12 shows the configuration such that the electron-emitting devices which are connected to the same column-directional wire are arranged being displaced in a row direction among the adjacent rows by a distance equivalent to a half of the interval between the electron-emitting devices in the row direction. The luminescent spot formed by these electron-emitting devices are also formed so as to be displaced as compared to the configuration in FIG. 2. By projecting the positions of respective reference points on the straight line extending in the first direction, the interval between the luminescent spots can be determined as the interval between the projected positions.

Regarding the electron-emitting device described above, a device which emits electrons when voltage is applied is preferable. The voltage here is given as a potential difference between two different electric potentials. Specifically, the two electric potentials are provided through two wires. It is especially preferable that the two wires are formed on a single substrate, but they may be formed on different substrates.

Also, there are various known electron-emitting devices.

For example, there are surface conduction electron-emitting devices, field emission type electron-emitting devices, MIM type electron-emitting devices, etc. Incidentally, the electron-emitting devices here are not limited to those with a single electron-emitting region per one electron-emitting device. For example, it is known that one electron-emitting device has two or more cone-shaped emitter electrodes as in the case of a so-called Spindt-type field emission type electron-emitting device with a gate electrode and cone-shaped emitter electrodes.

Also the luminescent spot which corresponds to one electron-emitting device described above means the luminescent spot formed by bombardment of the electrons emitted from a single electron-emitting device and has a particular shape.

The shape is determined here as follows.

Namely, electrons are emitted from the electron-emitting device to be intended to define the shape. It must be ensured that other electron-emitting devices will not emit electrons or cause the light emission from the other electron so intense as not to be visually checked even if other electron-emitting devices emit the electrons.

Then, the drive conditions used when prescribing the luminescent spot formed by the electrons from the electron-emitting device in question should be the standard drive conditions used when forming images by the image display apparatus.

Here, regarding modulation conditions in the standard drive conditions, if modulation for image formation is carried out by simply turning on and off the electron-emitting device (including pulse width modulation), the condition which turns on the electron-emitting device should be used, and if three- or higher-value peak-to-peak modulation is involved, the condition required to obtain the middle gradation between the lowest gradation (0 gradation) and highest gradation should be used.

In a configuration in which modulation is performed by controlling the flight of electrons with a grid electrode or the like which modulates the flight of electrons instead of controlling the electron emission state of the electron-emitting device itself, if modulation for image formation is performed by simply turning on and off the electron-emitting device (including pulse width modulation), the condition which turns on the modulation means should be used, and if three- or higher-value peak-to-peak modulation is involved, the condition required to obtain the middle gradation between the lowest gradation (0 gradation) and highest gradation should be used.

Then, under these conditions, an area which contains a portion glowing under bombardment by the electrons from the electron-emitting device in question should be photographed by a CCD camera under magnification (Image 1). Next, turning off driving of the electron-emitting device in question, the area should be photographed by the CCD camera (Image 2). In the image 1 and the image 2, whether driving of the electron-emitting device in question is turned on (Image 1) or off (Image 2) is only different. Then, from the data of the image 1, the data of the image 2 should be subtracted. Thereby, the luminescent spot corresponding to the electron-emitting device in question is only left. From this left luminescent spot, the shape of the luminescent spot should be obtained.

During actual image display, the luminescent spots formed by individual devices may overlap, but even in that case, the shape of the luminescent spot produced by each device can be determined by the above method. Besides, structures such as black stripes or a black matrix may be placed near the irradiated member of the image display apparatus, resulting in a chipped luminescent spot. Even in that case, the shape determined by the above method should be used as the shape of the luminescent spot. If luminescent spots are chipped by a black member (black stripe or black matrix), visual unevenness in luminance due to positional deviation of the luminescent spots and incidental unevenness in luminance due to the chipped luminescent spots present problems. The present invention is especially suitable for use in such situations.

Also, the above-mentioned light quantity of a luminescent spot, which is measured with a CCD camera, can be determined by integrating the luminance in the shape determined under the above conditions with respect to area and then further integrating the result with respect to a period given to the electron-emitting device which forms the luminescent spot to emit electrons while a single image is formed. This period is equivalent to a so-called scan period in typical image formation. It may be one line selection period in the case of line-sequential scanning in which electron-emitting devices arranged in a matrix are selected line by line and the electron-emitting devices on a selected line are driven simultaneously.

This light quantity can be controlled by controlling the amount of electrons which reach the irradiated member in a unit time or by controlling the length of time during which electrons are traveling to the irradiated member in the above described period.

Specifically, light quantity can be controlled, for example, by controlling the amount of electron emissions from the electron-emitting device in a unit time and the electron emission time during the above described period or by controlling the amount of electrons passing through a grid electrode in a unit time and the passage time of electrons during the above described period.

Thus, the light quantity of luminescent spot can be corrected by correcting the arrival conditions of electrons from the electron-emitting device for the given luminescent spot to the irradiated member (e.g., the drive conditions of the electron-emitting device or electron passage conditions of the grid electrode).

Incidentally, the above described arrival conditions may be corrected by correcting the amount of electrons arriving (emitted or passing) in a unit time: specifically, by correcting the voltage (or current) applied to the electron-emitting device or grid electrode, by correcting the electron arrival (emission or passage) time during the above-described period, or by correcting the duration of application (pulse width) of the voltage applied to the electron-emitting device to make it emit electrons or the electric potential applied to the grid electrode to make it pass electrons. Any of these corrections can be carried out by the correction processing for an input signal of the luminance signal or the like (by correcting the input signal, the corrected signal is output and due to this corrected signal, the modulation is carried out).

Also, the interval between luminescent spots described above can be determined by prescribing the shapes of the luminescent spots by above-described method, determining the center of gravity of each luminescent spot shape (assuming that the shape of a luminescent spot has a uniform mass distributions), and taking the interval between the centers of gravity as the interval between the luminescent spots. Thus, the position of a luminescent spots is the position of the center of gravity.

When using an irradiated member which glows in two or more luminescent colors, it is preferable to determine the luminescent spots needing correction and determine the amounts of correction, taking into consideration, at a time, only the luminescent spots which glow in the same color, as a group of luminescent spots to be evaluated. This means evaluating visual unevenness in luminance, determining the luminescent spots needing correction, and determining the amounts of correction, for each color separately.

The case of using phosphors which, for example, glow in red, green, and blue (R, G, B), respectively, will be described. The embodiment of the present invention is particularly suitable for a configuration in which phosphors which glow in red, green, and blue (or red, blue, and green), respectively, are arranged in sequence in the above described row direction and phosphors which glow in the same color are arranged in the column direction, if the group of luminescent spots to be evaluated are the luminescent spots formed by the phosphors which are arranged in the column direction and glow in the same color. However, visual unevenness in luminance may be evaluated without classifying the luminescent spots by color. In that case, luminance differences among colors should be compensated for before evaluating the visual unevenness in luminance.

For the detector 4 described above, there are various candidates. For example, the display panel has a spacer for maintaining an interval between the electron source 2 and irradiated member 3, especially considering pressure resistance under atmospheric pressure. If a spacer is used, for example, as the deflector 4, it will deflect electron trajectories when charged. Therefore, the spacer is one example of the deflector 4. If structural members such as spacers are installed in such a way that all the electrons emitted from all the electron-emitting devices will be affected in the same manner, the effects of different influences on images can be eliminated. Actually, however, it is often difficult to place structural members such as spacers in such a way that the electrons emitted from all the electron-emitting devices will be affected in the same manner.

In that case, it cannot be helped but to place structural members such as spacers in such a way that they will have a greater influence on the trajectories of the electrons with respect to the electron emitted from some of the electron-emitting devices. Specifically, spacers or the like are placed between adjacent electron-emitting devices in the state that a plurality of electron-emitting devices are disposed, but they are placed only in some of the intervals between adjacent electron-emitting devices.

In this case, spacers will have different influences on the trajectories of the electrons emitted from different electron-emitting devices depending on their closeness to the electron-emitting devices. For example, as described later, the existence of spacers or other structural members will change the center of gravity positions of the luminescent spots formed by the electrons emitted from the electron-emitting devices.

Thus, different influences caused by spacers or other structural members on the trajectories of the electrons emitted from different electron-emitting devices can cause variations in the intervals of the center of gravity positions of the luminescent spots formed by the electrons emitted from the electron-emitting devices.

In contrast, the embodiment of the present invention described above can reduce visual differences in brightness (unevenness in luminance) without making the intervals between luminescent spots uniform.

The spacer for maintaining an interval between the electron source 2 and irradiated member 3 can have various configurations. It does not necessarily have to make contact with the electron source 2 and irradiated member 3 to maintain an interval between them directly. For example, if another member such as a grid electrode is provided between the electron source 2 and irradiated member 3, the spacer may be placed between this member and the electron source or between this member and the irradiated member.

Also, the plurality of electron-emitting devices described above may have various layout configurations.

For example, when structural members such as spacers are placed in only part of the intervals between adjacent electron-emitting devices as described above, the intervals between adjacent electron-emitting devices can be varied. For example, intervals between adjacent electron-emitting devices which contain a structural member such as a spacer (first intervals) need not be equal to intervals between adjacent electron-emitting devices which do not contain a structural member such as a spacer (second intervals).

However, in this embodiment, it is possible that first intervals and second intervals are approximately equal. The embodiment of the present invention can suitably reduce visual differences in brightness even when the intervals between electron-emitting devices are equal, and furthermore, even when the intervals between electron-emitting devices are equal and intervals between luminescent spots are nonuniform.

Also, as the drive circuit described above, it is preferable to use, for example, a circuit which can control the arrival conditions of electrons from a plurality of electron-emitting devices arranged in a matrix to the irradiated member 3. The term “in a matrix” here means that something is arranged in the row and column directions, where the row direction and column direction are not parallel to each other and, more preferably, are approximately orthogonal to each other.

Then, the arrival conditions of electrons to the irradiated member 3 specifically include the amount of electrons reaching the irradiated member 3 or electron energy entering the irradiated member 3. To control the arrival conditions of electrons from the electron-emitting devices to the irradiated member 3, matrix control can be used. This involves a configuration in which one row is selected from among a plurality of rows and the arrival conditions of electrons to the irradiated member 3 is controlled from the column direction. Configurations for controlling the arrival conditions of electrons to the irradiated member 3 include, for example, controlling the state of electron emission itself or controlling the state of flight of emitted electrons.

Specifically, one row is selected from among a plurality of rows such that the electron-emitting devices arranged in the selected row can be driven through control from the column direction and that the devices arranged in the other rows cannot be driven through the above described control from the column direction. Then, each of the electron-emitting devices can be driven independently by the above-described control from the column direction.

Preferably, the drive circuit for use here will be configured to have a first circuit for selecting the plurality of rows in sequence and a second circuit for giving signals to the electron-emitting devices in the selected row to control electron emission from the column direction.

More particularly, the electron-emitting devices arranged in the row direction should be connected to a row-directional wire, the electron-emitting devices arranged in the column direction should be connected to a column-directional wire, the first circuit should be connected to the row-directional wire, and the second circuit should be connected to the column-directional wire.

In addition, an alternative configuration involves selecting one row from among a plurality of rows such that the electron-emitting devices arranged in the selected row will emit electrons while the devices arranged in the other rows will not emit electrons and controlling the arrival conditions of electrons emitted from the electron-emitting devices in the selected row to the irradiated member, from the column direction.

Preferably, the drive circuit for use here will be configured to have a first circuit for selecting the plurality of rows in sequence and making the electron-emitting devices in the selected row emit electrons and a second circuit for giving signals from the column direction to control the flight of the electrons emitted from the electron-emitting devices in the selected row.

More particularly, the electron-emitting devices arranged in the row direction should be connected to a set of wires which provides an electric potential difference served as a voltage for electron emission, the first circuit should be connected to this wiring, and the second circuit should be connected to an electrode which has been installed along the above described column direction and controls the flight of electrons, for example, an electrode which has an opening and controls the passage of electrons through this opening.

Also, when making the light quantity correction described above, preferably, means for adjusting the degree of correction is provided.

Such means of adjustment will allow manufactures, sellers, and users to make corrections so as to get desired conditions.

Incidentally, in the above discussion, mention has been made of reducing or increasing light quantity in relation to corrections made to the light quantity of luminescent spots. However, the corrections are relative. Thus, for example, corrections made so that the light quantity of a given luminescent spot will be smaller include reducing the light quantity of the given luminescent spot directly or increasing the light quantity of other luminescent spots, thereby reducing the light quantity of the given luminescent spot in a relative sense.

Also, as described above, these corrections work to make the light quantity of the luminescent spot unequal to that of other luminescent spots when an original signal before the corrections requests the same light quantity from the given luminescent spot and other luminescent spots to be uncorrected or luminescent spots to be corrected to a lesser degree. Such corrections can be made, for example, by correcting the drive conditions for forming the given luminescent spot.

In a preferred configuration, when an original signal makes a request, for example, to drive the electron emitting device which emits electrons for forming the given luminescent spot at a certain gradation, this gradation is corrected by a certain number or by a certain rate. For example, the light quantity will be reduced using the gradation obtained by subtracting 1 from the gradation requested by the original signal or the gradation obtained by subtracting 1% from the gradation requested by the original signal (and then rounding the result).

This correction method allows a luminescent spot to be corrected similarly even when an original signal before the correction requests different luminance from the given luminescent spot and other luminescent spots.

Also, as the electron-emitting device described so far, it is preferable to use a cold cathode electron-emitting device. More preferably, the electron-emitting device emits electrons by means of a cold cathode which applies a voltage between a pair of electrodes.

As the electron-emitting device which emits electrons by applying a voltage between a pair of electrodes, there are various devices as described above. It is preferable to use, for example, a Spin-type field emission type electron-emitting device which has a pair of a gate electrode and cone-shaped emitter electrode, MIM type electron-emitting device with a high resistance layer between electrodes, or surface conduction electron-emitting device, as described earlier.

In particular, the electron-emitting device can be preferably used if a deflector such as a spacer is, for example, a plate type which has the longitudinal direction in the in-plane direction of the electron source (its substrate), if the electron-emitting device used is a type which emits electrons by applying a voltage between a pair of electrodes, and if electrons are deflected (in the surface on which the electron-emitting devices are formed, by the voltage applied between the pair of electrodes in the same plane; known examples include surface conduction electron-emitting devices and horizontal EF devices), preferably the direction of the voltage between the pair of electrodes is not parallel to the direction normal to the longitudinal direction of a deflector, and more preferably the direction of the voltage between the pair of electrodes is parallel to the longitudinal direction of the deflector.

In addition, the image display apparatus according to the present embodiment as described above is particularly suitable for configurations in which an electron source and irradiated member are formed on substrates which are parallel to each other.

Also, it is particularly suitable for an electron source substrate and irradiated-member substrate with a 5-inch or larger screen (the diagonal of the screen area is 5 inches or larger).

Also, it is particularly suitable for configurations in which the interval between electron source and irradiated member is 1 cm or less.

In addition, to accelerate emitted electrons, a configuration in which a 5-kV or higher voltage is applied between electron-emitting devices and an accelerating electrode is preferable. The accelerating electrode is installed preferably near phosphors which glow when irradiated with electrons. The phosphors may double as the accelerating electrode.

In addition, regarding the electron source, it preferably comprises 240 or more electron-emitting devices each in the row and column directions. If images are formed using the three primary colors, it preferably comprises 240×240×3 or more electron-emitting devices.

### EXAMPLES

Now description will be given about examples configured more specifically based on the embodiment described so far.

In the examples described below, 240 electron-emitting devices are arranged in the column direction and 240 sets of electron-emitting devices for red, green, and blue (for a total of 720 electron-emitting devices) are arranged in the row direction.

### First Example

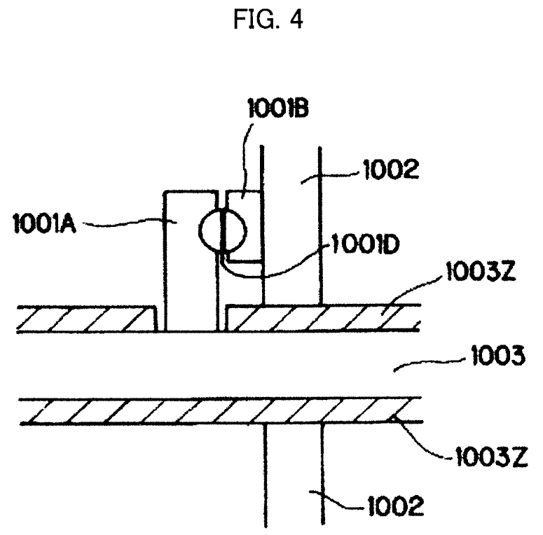

An image display apparatus according to a first example of the present invention will be described with reference to FIGS. 3 and 4. FIG. 3 is a schematic perspective view of the image display apparatus according to the first example of the present invention (some parts such as a glass substrate have been lifted for ease of understanding) while FIG. 4 is a partial plan view of an electron source for the image display apparatus.

According to the present example, a surface conduction electron-emitting device is employed as the electron-emitting device equipped with an electron-emitting region and installed in an electron source.

According to the present example, on an electron source substrate 10001, 720 surface conduction electron-emitting devices 1001 are arranged in the row direction and connected commonly to a row-directional wire 1003 while 240 surface conduction electron-emitting devices 1001 are arranged in the column direction and connected commonly to a column-directional wire 1002 to form matrix connections as shown in FIG. 3.

A drive circuit includes a scan circuit (first circuit) 1004 connected with the row-directional wires and a modulation circuit (second circuit) 1005 connected with the column-directional wires.

Besides, on the side opposite to the electron source substrate 10001, a glass substrate 10002, a phosphor 10003 formed on the glass substrate 10002 and serving as an irradiated member, and a metal back 10004 are stacked one on top of another.

Spacers 1006 serving as deflectors are provided between the electron source substrate 10001 and phosphor 10003. They are installed on some of the row-directional wires.

The electron-emitting devices 1001 in the row direction are spaced evenly. Also, in the column direction, adjacent electron-emitting devices 1001 placed on opposite sides of a spacer 1006 and adjacent electron-emitting devices 1001 placed on one side of a spacer 1006 are spaced equally.

Besides, a selection signal (selection potential) of −6.5 V is applied to a selected row-directional wire 1003 (ground potential of 0 V to non-selected row-directional wires) and a modulating signal (pulse width modulation signal in this case) is applied to the column-directional wires. For the column-directional wires, +6.5 V is used as an on-state potential and the ground potential is used as an off-state potential. As a modulation system, a pulse width modulation is employed. In other words, the length of time during which the on-state potential has been applied is determined on the basis of the corrected signal.

FIG. 4 is an enlarged view in the vicinity of an electron-emitting device 1001 on the electron source substrate 10001.

An insulating layer 1003Z is stacked on the column-directional wire 1002, and the row-directional wire 1003 is further stacked on top of them. The column-directional wire 1002 is connected with a device electrode 1001B which forms the electron-emitting device, the row-directional wire 1003 is connected with a device electrode 1001A which forms the electron-emitting device, and an electron-emitting region 1001D is formed between the device electrode 1001A and device electrode 1001B.

Also, the metal back 1004 consisting of aluminum is installed on a surface of the phosphor 1003 described above. It is used as an accelerating electrode to apply 6 kV according to this example.

Also, the interval between the electron source substrate 10001 and phosphor 10003 is set at 2 mm.

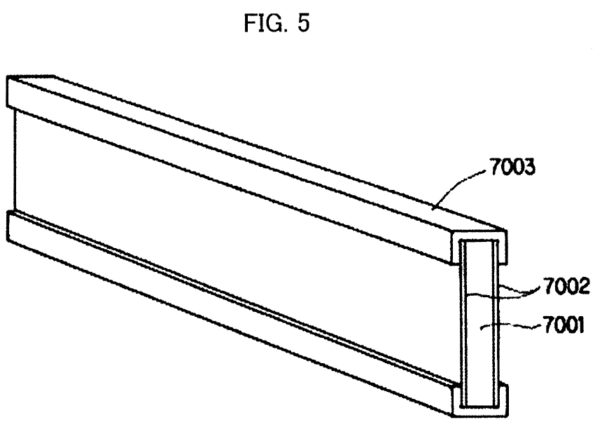

Next, the spacer will be described with reference to FIG. 5. FIG. 5 is a schematic perspective view of a spacer installed in the image display apparatus according to the first example of the present invention.

The spacer 1006 is electrically connected to the row-directional wire 1003 and metal back 10004. Its surfaces are covered with electroconductive chromic oxide films 7002. Platinum electrodes 7003 have been formed over the part where the spacer 1006 contacts the row-directional wire and metal back 10004.

In addition, the electroconductive films 7002 have been sputtered over the base metal 7001 of the spacer. The platinum electrodes 7003 which contact the row-directional wire 1003 and metal back 10004 have also been sputtered.

With the image display apparatus, when uniform standard drive conditions were given to all the electron-emitting devices in sequence so that the entire surface would glow, the locations of the spacers appeared brighter (hereinafter referred to as linear unevenness in luminance).

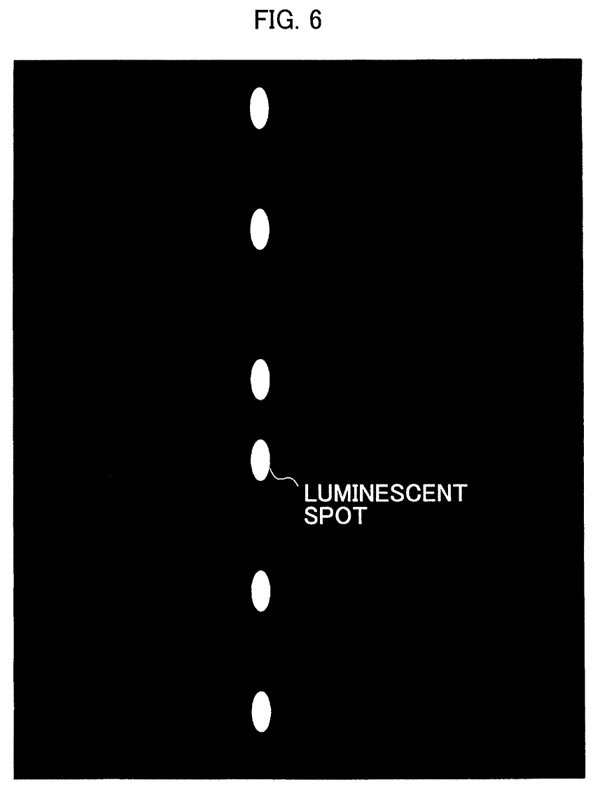

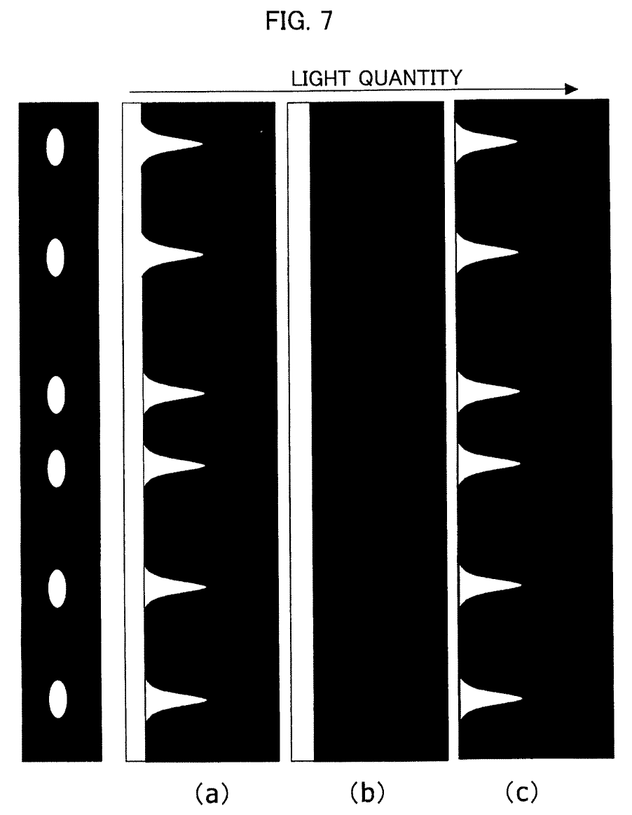

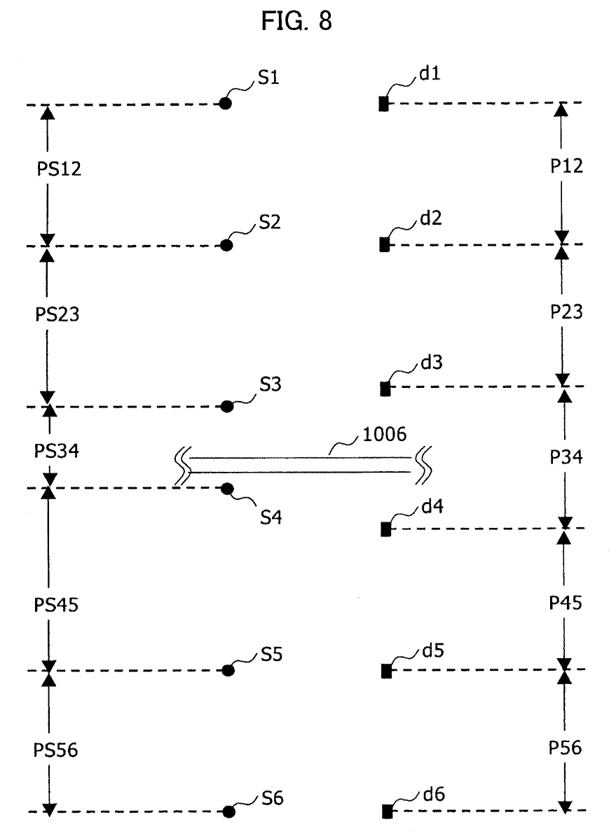

Then, the center of gravity positions of six luminescent spot in an area which contains a spacer 1006 were observed by the method described earlier. FIG. 6 shows an image where six luminescent spots in the area contains the spacer 1006 are measured by the CCD camera, namely, the light quantity data. Next, a method for obtaining profile data for obtaining the gravity positions of the luminescent spots from the light quantity data is shown in FIG. 7. At first, the light quantity data obtained in FIG. 6 is averaged in a horizontal direction, then, profile data (a) is obtained. In the same way, profile data (b) is obtained from an image which is obtained by projecting under the same conditions except for turning off the drive conditions of these six electron-emitting devices. By subtracting the profile data (b) as a back ground from the profile data (a), profile data (c) is obtained. Then, from the profile data (c), the center of gravity position of each luminescent spot is calculated. The results are shown in FIG. 8.

FIG. 8 schematically shows arrangement of the respective electron-emitting regions 1001D of the six electron-emitting devices d1 to d6. The intervals P12, P23, P34, P45, and P56 are equal and these intervals are defined as reference intervals P0.

On the other hand, reference characters S1 to S6 indicate relative center of gravity positions of the luminescent spots formed by the respective electron-emitting devices.

According to the configuration of the present example, intervals PS23, PS34, and PS45 between the adjacent luminescent spots are different from a reference interval P0 and PS12 and PS56 are equal to the reference interval P0. Further, PS34 is much smaller than other intervals and PS23 is narrower than PS45. The spacer 1006 as the deflector is arranged on the row-directional wire. Between the row-directional wires on which the spacers are arranged, nineteen row-directional wires having no spacer arranged thereon are sandwiched. In other words, when the spacer is arranged on the tenth row-directional wire from above, the spacer is not arranged on the twenty-ninth row-directional wire from the eleventh row-directional wire but the spacer is arranged on a thirtieth row-directional wire. As a result, the intervals where twenty electron-emitting devices can be arranged are provided between one spacer and another spacer. In these twenty electron-emitting devices, the intervals between the adjacent electron-emitting devices are mostly equal to the reference interval P0 and the average value of these intervals is slightly longer than the reference interval P0. The interval S34 between the adjacent luminescent spots S3 and S4 placed on opposite sides of the spacer is shorter than the average value.

Thus, in the present example, a correction was made to a drive condition of the electron-emitting devices d3 and d4 which emit electrons for forming luminescent spots S3 and S4. Specifically, with respect to the length (the width) of the pulse width modulation signal applied to the electron-emitting devices to emit electrons, the length of the PWM signal to be applied to the device d3 corresponding to the luminescent spot S3 was cut by 4%, and the length of the PWM signal to be applied to the device d4 corresponding to the luminescent spot S4 was cut by 2%, respectively. Thereby, a correction to relatively reduce the light quantities of the luminescent spots S3 and S4 than the light quantities of the luminescent spots S2 and S5, and a correction to relatively reduce the light quantity of the luminescent spot S3 than the light quantity of the luminescent spot S4.

As a result of these configurations, a bright line (brighter portion) near the spacer can be reduced.

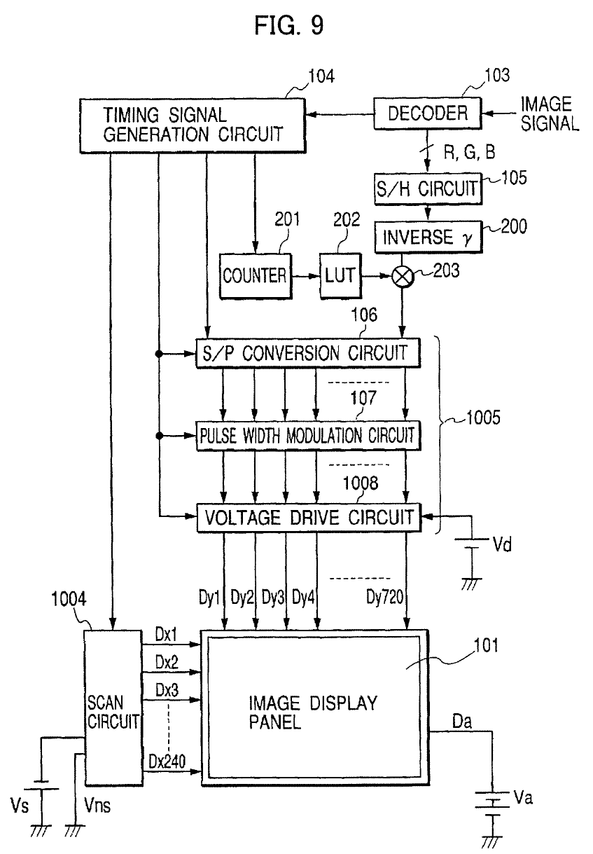

Now, a drive circuit for making corrections to light quantity will be described with reference to FIG. 9. FIG. 9 is a block diagram of the image display apparatus, including the drive circuit, according to the first example of the present invention.

An image display panel 101 employing surface conduction electron-emitting devices is connected to external electric circuits via terminals Dx1 to Dx240 connected to row-directional wires 1003, respectively, and via Dy1 to Dy720 connected to column-directional wires 1002, respectively.

Also, a high voltage terminal Da on the image display panel 101 is connected to an external high voltage power supply Va so that an electric potential for accelerating emitted electrons will be applied to it. A scan signal is applied to the terminal Dx1 to Dx240 to drive, row by row, the surface conduction electron-emitting devices matrix-wired on a multi-electron-beam source mounted in the panel.

On the other hand, a modulating signal is applied to the terminals Dy1 to Dy720 to control electron beams of each device output from the surface conduction electron-emitting devices in the row selected by the scan signal described above.

Next, the scan circuit 1004 will be described.

The scan circuit 1004 includes 240 switching elements corresponding to each of the row-directional wires. Each of the switching elements selects either a selection voltage Vs or non-selection voltage Vns to switch electrical connection to respective terminals Dx1 to Dx240 of the display panel 101.

In this case, the selection potential Vs and non-selection potential Vns are provided by an external power supply. Each switching element operates based on a scan start signal and scan clock output by a timing signal generation circuit 104, but actually these functions can be implemented easily by combining switching elements such as FETs.

Next, a flow of an image signal will be described. A decoder 103 separates an incoming composite image signal into a luminance signal of the three primary colors (RGB) and horizontal and vertical synchronizing signals (HSYNC and VSYNC). The timing signal generation circuit 104 generates various timing signals, including a sampling clock, a scan start signal, a scan clock, and a pulse width clock, in sync with the HSYNC and VSYNC signals. The RGB luminance signal is sampled and retained in an S/H circuit 105 by the sampling clock generated by the timing signal generation circuit 104.

The retained signal undergoes inverse gamma conversion in an inverse gamma conversion circuit 200. This example uses pulse width modulation, and gradation characteristics are substantially linear. Incoming TV signals have been corrected for gradation characteristics of the CRT, and thus the present example uses inverse gamma conversion to recover the original signal from the gamma-corrected signal.

In addition, in the drawings, a reference numeral 201 denotes a counter. Upon receiving various timing signals generated by the timing signal generation circuit 104, this counter generates a signal indicating the row to be driven and gives it to an LUT (look-up table) 202. The LUT 202 is a memory which constitutes a correction circuit for performing the light quantity correction described above.

The LUT 202 stores the correction values of each row (according to the above-described example, with respect to the row of the electron-emitting device d3, the correction value to reduce the gradation value by 4%, and with respect to the row of the electron-emitting device d4, the correction value to reduce the gradation value by 2%). The LUT 202 outputs the correction value for the row input from the counter 201 to a multiplier 203, which then multiplies the image signal by the correction value and outputs the corrected image signal. The present example corrects the linear unevenness in luminance by changing the image signal. According to the present example, the LUT 202 and the multiplier 203 are equivalent to a correction circuit to correct the light quantity of the luminescent spot.

The corrected signal is converted by a serial/parallel (S/P) conversion circuit 106 into parallel signals arranged in series which corresponds to the arrangement of each phosphors on an image-forming panel.

Then, a pulse width modulation circuit 107 generates pulses with pulse width corresponding to image signal strength. A voltage drive circuit 1008 outputs a predetermined electric potential (+6.5 V) for the duration of the pulse width. The electron-emitting devices of the display panel are simple-matrix driven by a signal output from the scan circuit 1004 described above and a signal from the voltage drive circuit 1008.

Although the present example employs a method which involves multiplying the image signal by a correction value, this is not restrictive. Another correction method such as inverse gamma conversion described in relation to the present example may be used in conjunction. In that case, it is preferable to use a common correction circuit for the other correction and the luminance correction in accordance with intervals between luminescent spots which is directly relevant to the present invention. If inverse gamma conversion is used in conjunction, for example, an inverse gamma conversion table should contain data for the correction in accordance with intervals between luminescent spots.

In addition, instead of a method which changes image signals, any other method may be used as long as it provides luminance in accordance with correction values.

According to the above-described example, adjacent two luminescent spots (S3 and S4) placed on opposite sides of the deflector (spacer 1006) approach the deflector, respectively and even when its moving quantity is different, by correcting the light quantity of the luminescent spots, an image quality can be improved because the correction quantity is adjusted so that the luminance are uniformed visually taking a magnitude relation of the moving quantity (interval) of respective luminescent spots into consideration.

The above correction alleviated differences in visual brightness and made the bright line near the spacer inconspicuous.

### Second Example

The present example will further correct external luminescent spots in addition to the correction according to the first example.

According to the first example, as described above, the correction was made for luminescent spots S3 and S4 adjacent to the spacer. On the contrary, according to the present example, the correction is also made for S2 and S5. Thereby, the image quality can be further improved because further visual uniform distribution of luminance can be obtained.

Specifically, the correction was made with respect to the length (the width) of the pulse width modulation signal applied to the electron-emitting devices to emit electrons, the length of the PWM signal to be applied to the device d3 corresponding to the luminescent spot S3 was cut by 4%, and the length of the PWM signal to be applied to the device d4 corresponding to the luminescent spot S4 was cut by 2%, respectively. Further, the correction was made so that the length of the PWM signal to be applied to the device d2 corresponding to the luminescent spot S2 was increased by 1%, and the length of the PWM signal to be applied to the device d5 corresponding to the luminescent spot S5 was increased by 2%, respectively. Thereby, a correction to relatively reduce the light quantity of the luminescent spot S2 than the light quantity of the luminescent spot S5. As a result of these configurations, a bright line (brighter portion) near the spacer can be reduced.

### Third Example

According to the configuration of the present example, when an image is formed under a standard drive conditions, the locations of the spacers appears darker. Other points are the same as the first example.

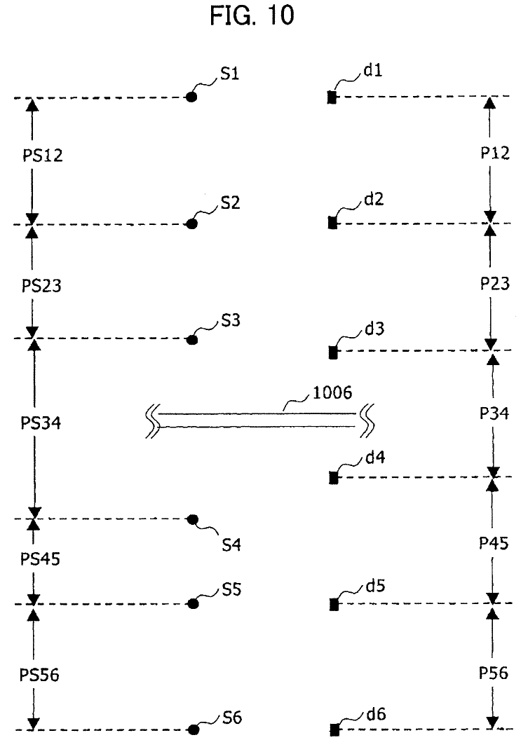

Here, the center of gravity of the luminescent spots in the area which contains the spacer 1006 were observed by the method described above. The results are shown in FIG. 10.

FIG. 10 schematically shows arrangement of the respective electron-emitting regions 1001D of the six electron-emitting devices d1 to d6. The intervals P12, P23, P34, P45, and P56 are uniform.

On the other hand, reference characters S1 to S6 denote relative center of gravity positions of the luminescent spots formed by the respective electron-emitting devices.

According to the configuration of the present example, intervals PS23, PS34, and PS45 between the adjacent luminescent spots are different from a reference interval and PS12 and PS56 are equal to the reference interval P0. Further, PS34 is much broader than other intervals and PS23 is broader than PS45. In the spacers, the average value of the intervals between the adjacent luminescent spots is slightly shorter than the reference interval P0.

Thus, in the present example, a correction was made to a drive condition of the electron-emitting devices d3 and d4 which emit electrons for forming luminescent spots S3 and S4. Specifically, with respect to the pulse width modulation signal applied to the electron-emitting devices to emit electrons, the length of the PWM signal to be applied to the device d3 corresponding to the luminescent spot S3 was increased by 5%, and the length of the PWM signal to be applied to the device d4 corresponding to the luminescent spot S4 was increased by 3%, respectively.

As a result of these configurations, a dark line (darker portion) near the spacer can be reduced.

According to the present example, adjacent two luminescent spots (S3 and S4) placed on opposite sides of the deflector (spacer 1006) move away from the deflector, respectively and even when its moving quantity is different, by correcting the light quantity of the luminescent spots, an image quality can be improved because the correction quantity is adjusted so that the luminance are uniformed visually taking a magnitude relation of the moving quantity (interval) of respective luminescent spots into consideration.

### Fourth Example

According to the present example, a correction will be further made to luminescent spots located outside in addition to the correction according to the third example.

According to the third example, as described above, the correction was made for luminescent spots S3 and S4 adjacent to the spacer. On the contrary, according to the present example, the correction is also made for S2 and S5. Thereby, the image quality can be further improved because further visual uniform distribution of luminance can be obtained.

Specifically, the correction was made so that the length of the pulse width modulation signal to be applied to the electron-emitting device d3 corresponding to the luminescent spot S3 for emitting electrons was increased by 5%, and the length of the PWM signal to be applied to the device d4 corresponding to the luminescent spot S4 was increased by 3%, respectively. Further, the correction was made so that the length of the PWM signal corresponding to the luminescent spot S2 was increased by 2%, and the length of the PWM signal corresponding to the luminescent spot S5 was increased by 1%, respectively. As a result of these configurations, a dark line (darker portion) near the spacer can be reduced.

### Fifth Example

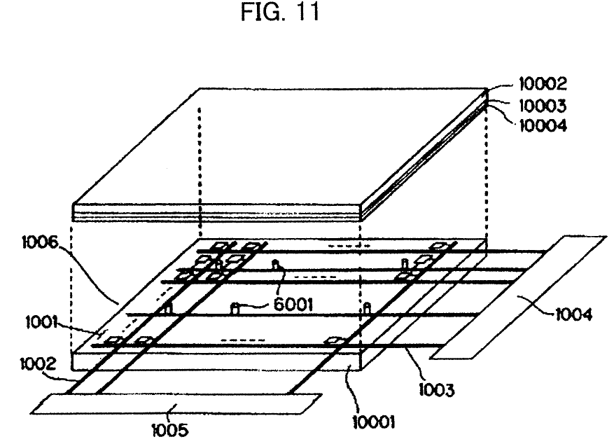

The methods described in the first to fourth examples have various modifications. For example, even when a columnar spacer having a longitudinal direction in a direction of the interval between the electron source substrate and the phosphor is used, the present invention can be preferably employed. The configuration in that case is shown in FIG. 11. FIG. 11 is a schematic perspective view of an image display apparatus according to the fifth example of the present invention.

The configuration of FIG. 11 uses a columnar spacer 6001 in place of the spacer 1006 used in FIG. 3. Also, in this configuration, the spacer differently influence the trajectory of the electron emitted from the electron-emitting device nearest to the spacer 6001 and the trajectory of the electron emitted from the electron-emitting device more distant from the spacer 6001. Also, in this configuration, it is possible to reduce visual unevenness in luminance according to the methods described in the first, second, third or fourth examples.

The correction values for the electron-emitting devices connected to the same row-directional wire may be same in the first, second, third, and fourth examples, however, on the contrary, according to this example, even the electron-emitting devices connected to the same row-directional wire have different distances from the nearest spacer, respectively. Therefore, determining whether the correction is needed or not in each of the electron-emitting devices connected to the same row-directional wire and how much the correction is needed, the LUT 202 as correction value memory necessarily stores them.

The present invention has been described with reference to the examples, however, it is to be understood that the specific circuit configuration to make the present invention into practice is not limited to the configuration shown in FIG. 9.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-052330, filed on Feb. 28, 2006, which is hereby incorporated by reference herein in its entirety.

What is claimed is:

1. An image display apparatus comprising:
a plurality of electron-emitting devices;
an irradiated member which is arranged so as to be opposed to the plurality of electron-emitting devices to form luminescent spots on different locations, respectively, in response to respective electron-emitting devices due to irradiation of electrons emitted from the electron-emitting devices;
a plurality of deflectors for deflecting trajectories of the electrons emitted from the electron-emitting devices; and
a correction circuit for correcting the light quantity of the luminescent spot;
wherein the plurality of deflectors includes at least first and second deflectors which are located at a distance where three or more electron-emitting devices can be arranged in a first direction;
among four luminescent spots A2, A1, B1, and B2 formed adjacent in sequence, respectively, by four electron-emitting devices arranged in the first direction, the first deflector is located between the luminescent spots A1 and B1;
the interval between the luminescent spots A1 and B1 in the first direction is narrower than the average value of the intervals in the first direction of the adjacent luminescent spots between the first and second deflectors and the interval between the luminescent spots A2 and A1 in the first direction is narrower than the interval between the luminescent spots B1 and B2 in the first direction; and
the correction circuit makes a correction so that the light quantities of the luminescent spots A1 and B1 are relatively smaller than the light quantities of the luminescent spots A2 and B2 and the light quantity of the luminescent spot A1 is relatively smaller than the light quantity of the luminescent spot B1 when an input signal is a signal to require the same light quantities from the luminescent spots A2, A1, B1, and B2.

2. The image display apparatus according to claim 1,
wherein the correction circuit makes a correction so that the light quantity of the luminescent spot A2 is relatively smaller than the light quantity of the luminescent spot B2 when an input signal is a signal to require the same light quantities from the luminescent spots A2, A1, B1, and B2 and when the correction circuit makes a correction so that the light quantities of the luminescent spots A1 and B1 are relatively smaller than the light quantities of the luminescent spots A2 and B2 and the light quantity of the luminescent spot A1 is relatively smaller than the light quantity of the luminescent spot B1.

3. An image display apparatus comprising:
a plurality of electron-emitting devices;
an irradiated member which is arranged so as to be opposed to the plurality of electron-emitting devices to form luminescent spots on different locations, respectively, in response to respective electron-emitting devices due to irradiation of electrons emitted from the electron-emitting devices;
a plurality of deflectors for deflecting trajectories of the electrons emitted from the electron-emitting devices; and
a correction circuit for correcting the light quantity of the luminescent spot;
wherein the plurality of deflectors includes at least first and second deflectors which are located at a distance where three or more electron-emitting devices can be arranged in a first direction;
among four luminescent spots A2, A1, B1, and B2 formed adjacent in sequence, respectively, by four electron-emitting devices arranged in the first direction, the first deflector is located between the luminescent spots A1 and B1;
the interval between the luminescent spots A1 and B1 in the first direction is broader than the average value of the intervals in the first direction of the adjacent luminescent spots between the first and second deflectors and the interval between the luminescent spots A2 and A1 in the first direction is broader than the interval between the luminescent spots B1 and B2 in the first direction; and
the correction circuit makes a correction so that the light quantities of the luminescent spots A1 and B1 are relatively larger than the light quantities of the luminescent spots A2 and B2 and the light quantity of the luminescent spot A1 is relatively larger than the light quantity of the luminescent spot B1 when an input signal is a signal to require the same light quantities from the luminescent spots A2, A1, B1, and B2.

4. The image display apparatus according to claim 3,
wherein the correction circuit makes a correction so that the light quantity of the luminescent spot A2 is relatively larger than the light quantity of the luminescent spot B2 when an input signal is a signal to require the same light quantities from the luminescent spots A2, A1, B1, and B2 and when the correction circuit makes a correction so that the light quantities of the luminescent spots A1 and B1 are relatively larger than the light quantities of the luminescent spots A2 and B2 and the light quantity of the luminescent spot A1 is relatively larger than the light quantity of the luminescent spot B1.
